(19) United States
(12) Patent Application Publication
(10) Pub. No.: US 2013/0102997 A1
(43) Pub. Date: Apr. 25, 2013

(54) DISPENSING MECHANISM WITH FOAM-FILLED NIPPLE

(71) Applicants: Hamidreza Abbassmovahedi, Hollister, CA (US); Anthony Ray Morales, Hollister, CA (US); Johnny Joseph Morales, San Jose, CA (US)

(72) Inventors: Hamidreza Abbassmovahedi, Hollister, CA (US); Anthony Ray Morales, Hollister, CA (US); Johnny Joseph Morales, San Jose, CA (US)

(21) Appl. No.: 13/279,357

(22) Filed: Oct. 24, 2011

(51) Int. Cl. A61J 7/00; A61J 17/00; A61D 7/00

(52) U.S. Cl. 604/514; 604/77; 606/234

(57) ABSTRACT

The present invention discloses a dispensing device. The dispensing device includes a chamber subassembly coupled to a mouth guard subassembly. The mouth guard subassembly includes a mouth guard adjacent to an end of the chamber subassembly, a nipple extending from the mouth guard, and foam disposed within the interior of the nipple.

### FIELD OF INVENTION

This invention relates generally to feeders and dispensers, and more particularly, to an improved dispensing apparatus used to deliver medicaments, nutrients, and other substances.

### BACKGROUND OF THE INVENTION

Dispensing devices, particularly those made for infants such as dispensing pacifiers, are made according to various types and often include a porous nipple from where fluid dispenses. Dispensing pacifiers are used to appease crying children and to discourage thumb-sucking and other idiosyncrasies. In many instances, dispensing pacifiers are dipped in honey, syrup, or topical oral medication to serve as a tranquilizing agent for infants. Unfortunately, the effects are short-lived, for the dipped coating is rapidly diluted by saliva requiring the pacifier to be dipped repeatedly.

It is generally difficult to administer medicines or vitamins orally, particularly those which have an unpleasant taste or aroma to infants and children. Various container types, including porous and non-porous pacifiers, have been disclosed in the prior art which provide containment and delivery means for medication or nutritious substances. For example, U.S. Pat. No. 2,612,165, U.S. Pat. No. 2,824,561, U.S. Pat. No. 2,889,829, and U.S. Pat. No. 4,192,307 disclose pacifiers which feature perforated or micro-porous hollow nipples and containment means for viscous liquid medications or nutrients.

Such pacifiers, although generally adapted for administering medicines in liquid form, do not accurately measure medicine dosages. Furthermore, filling the containment reservoir is often difficult, causing spillage and waste of medicine. In the case of a micro-porous nipple, the sucking action by an infant can collapse the nipple and prevent the infant from ingesting a complete dosage.

FIG. 1A illustrates a perspective view of a prior art dispensing device. As shown, dispensing device 100 includes a chamber 108, a mouth guard 102 adjacent thereto, and a nipple 103 adjacent to the mouth guard 102. As such, mouth guard 102 is disposed between chamber 108 and nipple 103. In addition, chamber 108 includes a plunger 105 operable to move therein along an axis parallel to the exterior wall of the chamber 108. Typically, chamber 108 is filled with a substance. Once filled with a substance, dispensing device 100 is operable to dispense the substance through the porous nipple 103.

Moving forward, FIG. 1B illustrates a bottom view of an exemplary prior art dispensing device exposing a porous nipple. As shown, nipple 103 includes a plurality of pores 107 which release a contained substance from the nipple 103 upon a sucking action.

Accordingly, there exists a need for a pacifier which provides an accurate measuring and dispensing mechanism for substances to those whom lack the capacity to administer the substances to themselves.

### SUMMARY OF THE INVENTION

The present invention discloses a dispensing device. The dispensing device includes a chamber subassembly coupled to a mouth guard subassembly. The mouth guard subassembly includes a mouth guard adjacent to an end of the chamber subassembly, a nipple extending from the mouth guard, and foam disposed within the interior of the nipple.

### BRIEF DESCRIPTION OF THE FIGURES

For a fuller understanding of the nature and objects of the invention, reference should be had to the following detailed description taken in connection with the accompanying drawing forming a part of this specification and in which similar numerals of reference indicate corresponding parts in all the figures of the drawing:

FIG. 1A illustrates a perspective view of an exemplary dispensing device of the prior art.

FIG. 1B illustrates a bottom view of an exemplary prior art dispensing device exposing a porous nipple.

FIG. 2A illustrates a perspective view of a dispensing device according to an embodiment of the present invention.

FIG. 2B illustrates a bottom view of a dispensing device exposing a plurality of pores on a nipple component according to an embodiment of the present invention.

FIG. 2C illustrates a bottom view of a dispensing device exposing a single pore on a nipple component according to an embodiment of the present invention.

FIG. 3 illustrates an exploded view of a dispensing device according to an embodiment of the present invention.

FIG. 4A illustrates a cross-sectional view of a disengaged dispensing device according to an embodiment of the present invention.

FIG. 4B illustrates a cross-sectional view of an engaged dispensing device according to an embodiment of the present invention.

FIG. 5A illustrates a perspective view of a dispensing device in an disconnected and unlocked position according to an embodiment of the present invention.

FIG. 5B illustrates a perspective view of a dispensing device in a connected but unlocked position according to an embodiment of the present invention.

FIG. 5C illustrates a perspective view of a dispensing device in a connected and locked position according to an embodiment of the present invention.

FIG. 6 illustrates a perspective view of an individual pouring medicament into a dispensing device according to an embodiment of the present invention.

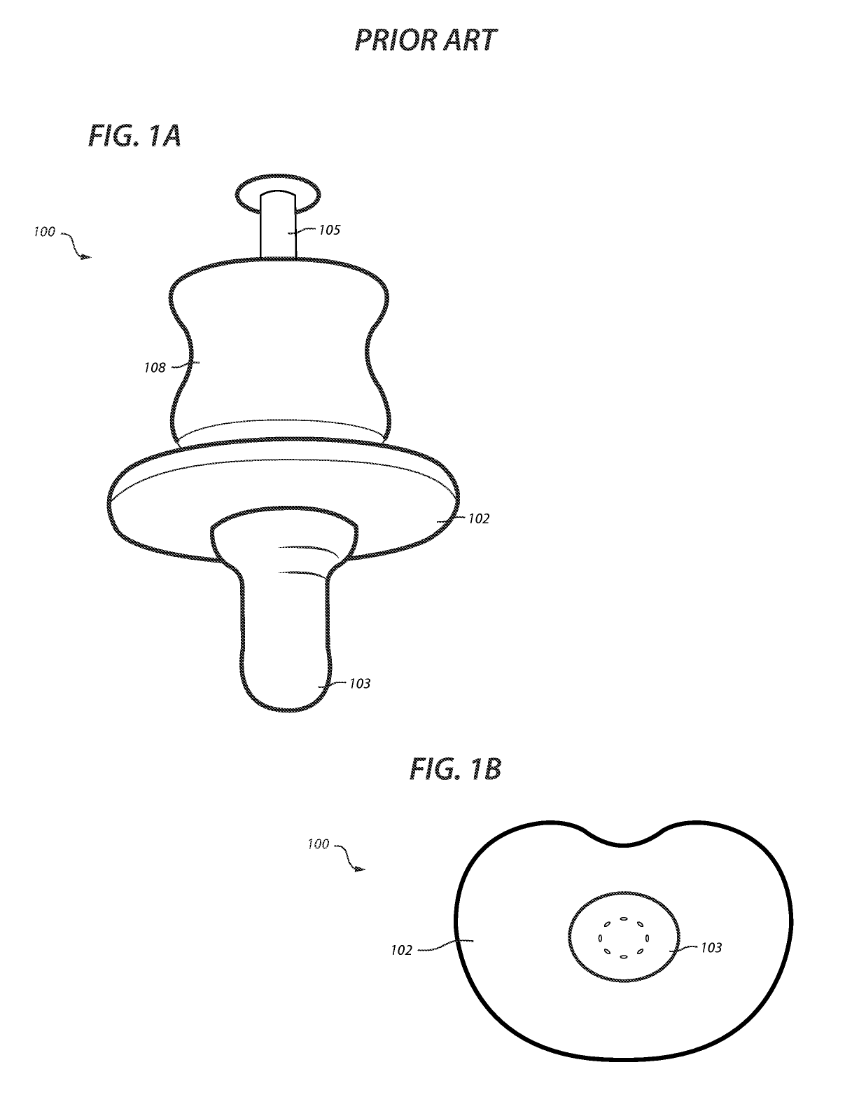

### DETAILED DESCRIPTION

This invention relates generally to feeders and dispensers, and more particularly, to an improved dispensing apparatus used to deliver medicaments, nutrients, and other substances. The following description is presented to enable one having ordinary skill in the art to make and use the embodiment and is provided in the context of a patent application. The generic principles and features described herein will be apparent to those skilled in the art. Thus, the present embodiment is not intended to be limited to the embodiments shown, but is to be accorded the widest scope consistent with the principles and features described herein.

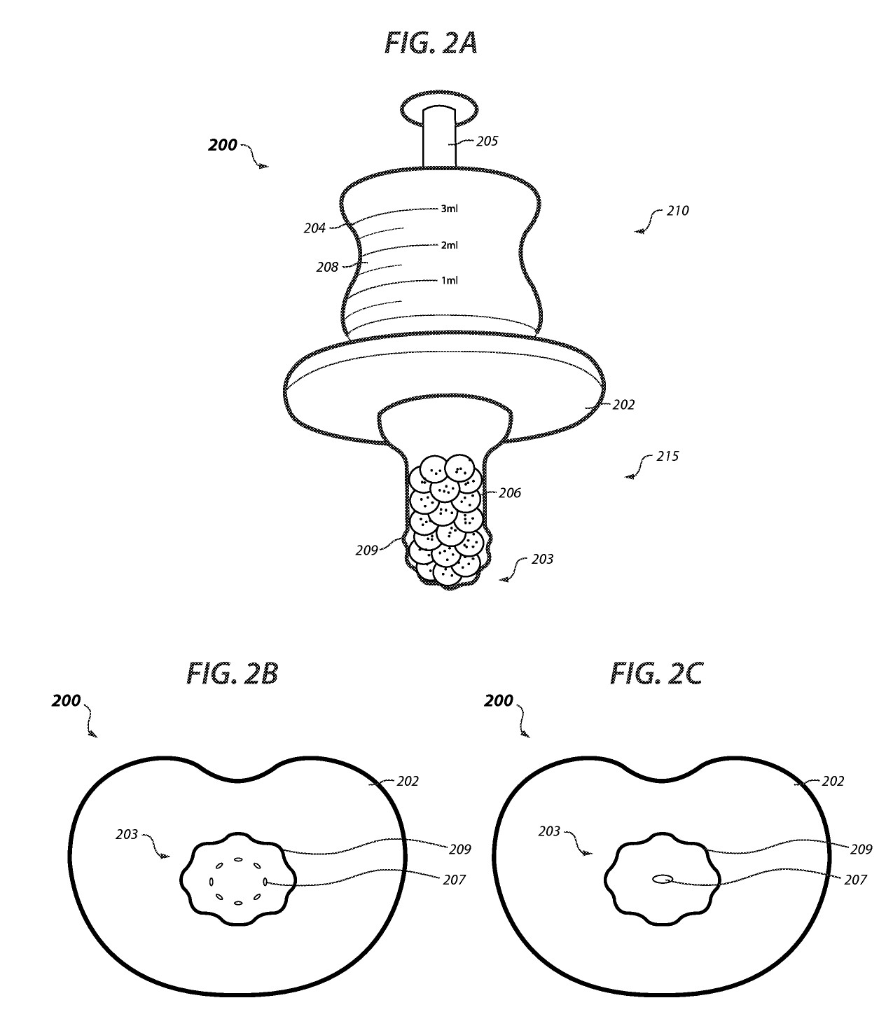

FIG. 2A illustrates a perspective view of a dispensing device 200 according to an embodiment of the present invention. As shown, dispensing device 200 includes a chamber subassembly 210 connected to a mouth guard subassembly 215. As shown, when the two subassemblies are connected together, the combined assembly serves as a dispensing device 200.

Chamber subassembly 210 is operable to contain a substance within a chamber 208 and deliver the substance to the nipple 203 component of mouth guard subassembly 215. In the embodiment shown, chamber subassembly 210 includes a chamber 208 and a plunger 205. Plunger 205 is operable to extend through a first end of the chamber 208 and is movable along a first axis of the chamber 208, according to an embodiment of the present invention.

Chamber subassembly 210 also includes a plurality of measurement tick marks 204 on the surface of chamber 208. In an embodiment, measurement tick marks 204 provide a measuring mechanism to determine how much substance is contained within chamber 208. For example, chamber 208 can contain up to three milliliters of a fluid-based substance which may be indicated by the peak level of a fluid-based substance and the nearest measurement tick mark 204 on the surface of the chamber 208. One having ordinary skill in the art understands how to visually determine the amount of a substance within a container by matching the peak level of the substance with the corresponding measurement tick mark on the surface of a container.

Dispensing device 200 further includes a mouth guard subassembly 215 which includes a mouth guard 202, nipple 203 with foam members 206 therein, and a snap component (not shown). In an embodiment when the device 200 is disassembled, mouth guard subassembly 215 serves as a conventional pacifier. Mouth guard 202 may comprise rubber, silicone, or any other durable and non-toxic material. In addition, mouth guard 202 may comprise aesthetic components or materials such as a glow in the dark material.

The present invention is not limited to one type of mouth guard subassembly. For example, mouth guard subassembly may include a basic or orthodontic configuration. In addition, mouth guard subassembly may be configured as a conventional pacifier and may be used by premature babies, infants, babies from 3-6 months in age, and babies from 6-18 months in age. Mouth guard subassembly may also be characterized as any pacifier selected from the group consisting of soothie pacifiers, freeflow pacifiers, night time pacifiers, translucent pacifiers, and fashion pacifiers. In addition, nipple 203 may include ridges disposed thereon to soothe one's teeth and gums during use.

FIG. 2B illustrates a bottom view of a dispensing device exposing a plurality of pores on a nipple component, according to an embodiment of the present invention. As shown, dispensing device 200 includes a plurality of pores 207 on the exterior surface of nipple 203. The size of each pore 207 may range from 1 mm to 2 mm. In an embodiment, the size of each pore 207 is approximately 1 mm. In yet other embodiments of the present invention, the plurality of pores 207 vary in size such that there is no uniform size among the pores 207 on the nipple 203.

In an embodiment, the size of the pores 207 in FIG. 2B is greater than the size of pores in prior art systems because the plurality of foam members within the nipple 203 help retain a substance within the nipple 203 when the dispensing device 200 is disengaged and when an individual is not applying a sucking action on the nipple 203.

Foam members 206 may comprise any type of foam and may be any size to substantially absorb substances contained within the device 200 and impede the flow of substances from the device 200 when the dispensing device is not engaged. In an embodiment, foam members 206 comprise of foam made from CleanWIPE® Tip Foam Swab. In the embodiment, the dimensions of each foam member 206 are approximately 34 mm length by 10 mm width by 6 mm height. In yet other embodiments, foam members 206 comprise foam made from 3M Corporation's O-Cel-O sponge.

The present invention, however, is not limited to foam members 206 with the aforementioned dimensions. As such, foam members 206 may have varying shapes and sizes. Moreover, foam members 206 may have varying shapes and sizes, with respect to each other, such that as a group, foam members 206 are non-uniform.

The aforementioned components of dispensing device 200 function in cooperation with each other to enable dispensing device 200 dispense substances, allow the mouth guard subassembly to function as a conventional pacifier device when the chamber subassembly and mouth guard subassembly are disconnected, and provide a soothing mechanism for one's teeth and gums during use.

Moving forward, FIG. 2C illustrates a bottom view of a dispensing device 200 exposing mouth guard 202 and a single pore 207 on a nipple component 203 according to an embodiment of the present invention. In an embodiment, the size of single pore 207 is approximately 5 mm. Because dispensing device 200 includes foam members to help retain a substance within the device 200, the size of the single pore 207 may be larger than the size of pores in prior art systems. Further, since the embodiment shown only includes a single pore 207, pore 207 may be wider than pores in the prior art such that a substance is suitably dispensed when a sucking action is applied to nipple 203. Moreover, the size of pore 207 is bigger than the pores shown in FIG. 2B according to an embodiment of the present invention.

It should be appreciated by those having ordinary skill in the art that the present invention is not limited to a nipple with one or more pores. As such, the present invention may include any style of openings in the nipple 203 which allows a substance to be dispensed when a sucking action is applied. For example, a slit or plurality of slits may be disposed on the external surface of the nipple 203 through which a substance flows there through when the dispensing device is engaged.

In an embodiment when nipple 203 has slits, the length of the slits are approximately 10 mm. In the embodiment, the nipple 203 comprises latex which causes the 10 mm slits to close when a sucking action is not applied. As such, when the dispensing device 200 is not in use, the slits appear as 1 mm in length pores and help retain substances within the nipple 203.

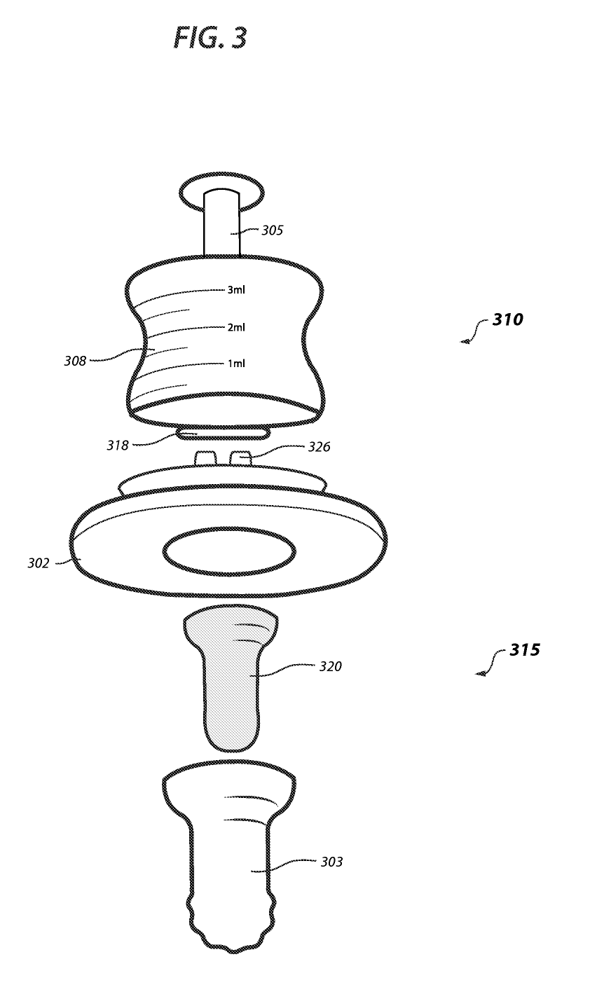

Moving through the figures, FIG. 3 illustrates an exploded view of a dispensing device according to an embodiment of the present invention. As shown, a disassembled dispensing device 300 includes a chamber subassembly 310 which includes a plunger 305, chamber 308, and first locking component 318 (e.g. connection rod). FIG. 3 further illustrates a mouth guard subassembly 315 which includes a second locking component 326 (e.g. snap component) disposed on an exterior base portion of mouth guard 302, and a nipple component 303.

In the embodiment shown, dispensing device 300 includes a single foam member 320 disposed between mouth guard 302 and nipple 303. As illustrated, foam member 320 is shaped similarly to nipple 303 which when configured fits within the interior of nipple 303. In addition, the figure shows that foam member 320 is a single body according to an embodiment of the present invention.

In an embodiment, foam member 320 is porous and can absorb substances and release substances when a sucking action is applied to the nipple 303. However, it should be understood by one having ordinary skill in the art that the present invention is not limited to a single foam member similarly shaped to a nipple. For example, a plurality of foam members can be disposed within nipple, as illustrated previously in FIGS. 2.

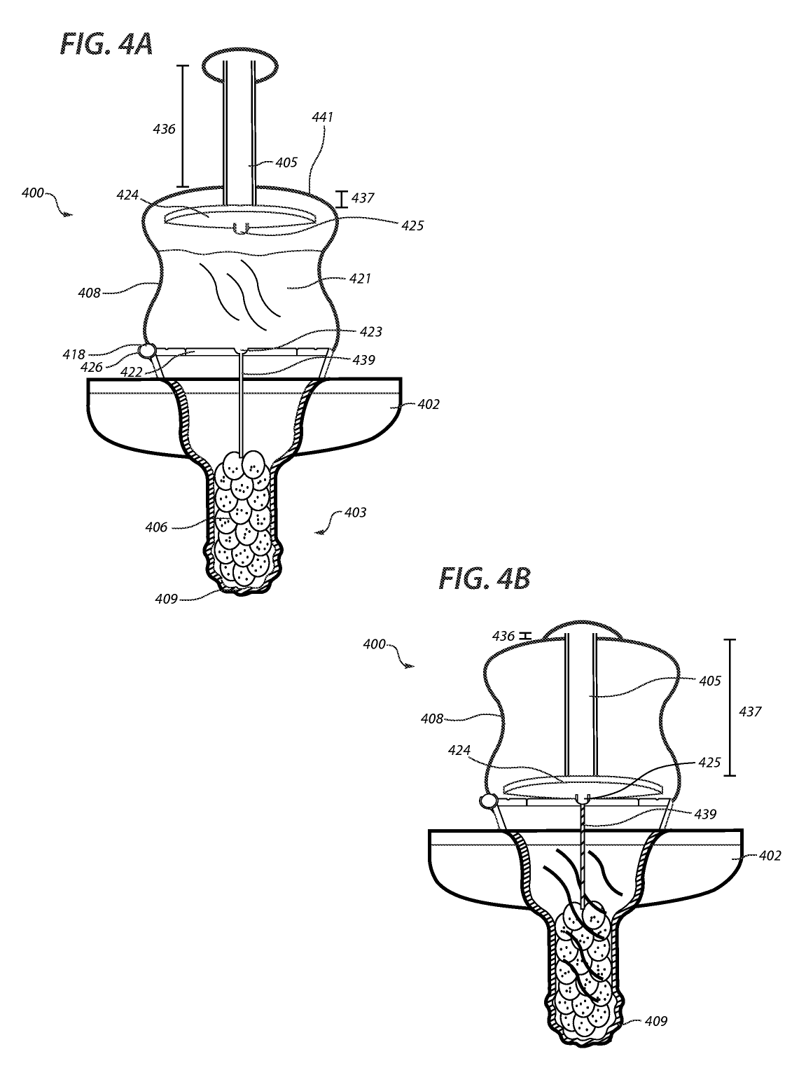

Moving along through the figures, FIG. 4A illustrates a cross-sectional view of a disengaged dispensing device 400, in accordance with an embodiment of the present invention. In the embodiment shown, when dispensing device 400 is in a disengaged position, the lid component 424 of plunger 405 is not in physical contact with a fluid substance 421 within the chamber 408.

In another embodiment, dispensing device 400 is disengaged when plunger 405 extends primarily outside of chamber 408 and lid component 424 contacts the roof of the chamber 408. As such, when dispensing device 400 is disengaged, the distance 436 between the top of plunger 405 and the top portion 441 of chamber 408 is at its maximum. Alternatively, when the device 400 is engaged, the distance 437 between the top portion 441 of chamber 408 and lid component 424 is at its minimum.

In an embodiment when device 400 is disengaged, fluid substance 421 is present primarily in chamber 408. As such, fluid substance 421 does not enter nipple 403 until the device 400 is engaged according to an embodiment of the present invention. However, the present invention is not so limited that a disengaged dispensing device 400 contains all of fluid substance 421 within the chamber 408 component. Therefore, some fluid substance may seep to the nipple 403 when the dispensing device 400 is disengaged and this would be consistent with the present invention.

FIG. 4A further illustrates a mouth guard 402 which includes a plate 422 disposed near a center portion of the guard 402. In an embodiment of the present invention, plate 422 helps contain fluid substances 421 within chamber 408. Without the aid of plate 422, the substance 421 may be displaced to nipple 403 without an administrator engaging device 400.

Alternatively, when dispensing device 400 is engaged, fluid substance 421 is present primarily within the interior of nipple 403. To engage dispensing device 400, an administrator can push plunger 405 towards the bottom of chamber 408 at a steady rate through chamber 408 and cavity 439 to nipple 403. In an embodiment, when dispensing device 400 is engaged, an extension portion 425 of lid component 424 fits securely within a portion 423 of plate 422.

In time, fluid substance 421 is absorbed by foam members 406 and retained until released via a sucking action by a user. Typically, the individual is anyone with impaired or under-developed motor skills such as an infant, toddler, child, senior, or medical patient. In other embodiments, the dispensing device 400 may be used to administer substances to a pet.

For example, once dispensing device 400 is engaged and the fluid substance 421 is delivered to and absorbed by the plurality of foam members 406, the substance 421 can be dispensed from the device 400 upon a sucking action by a user. When the user is an infant, the infant's teeth and gums may be soothed by ridges 409 disposed upon the nipple 403.

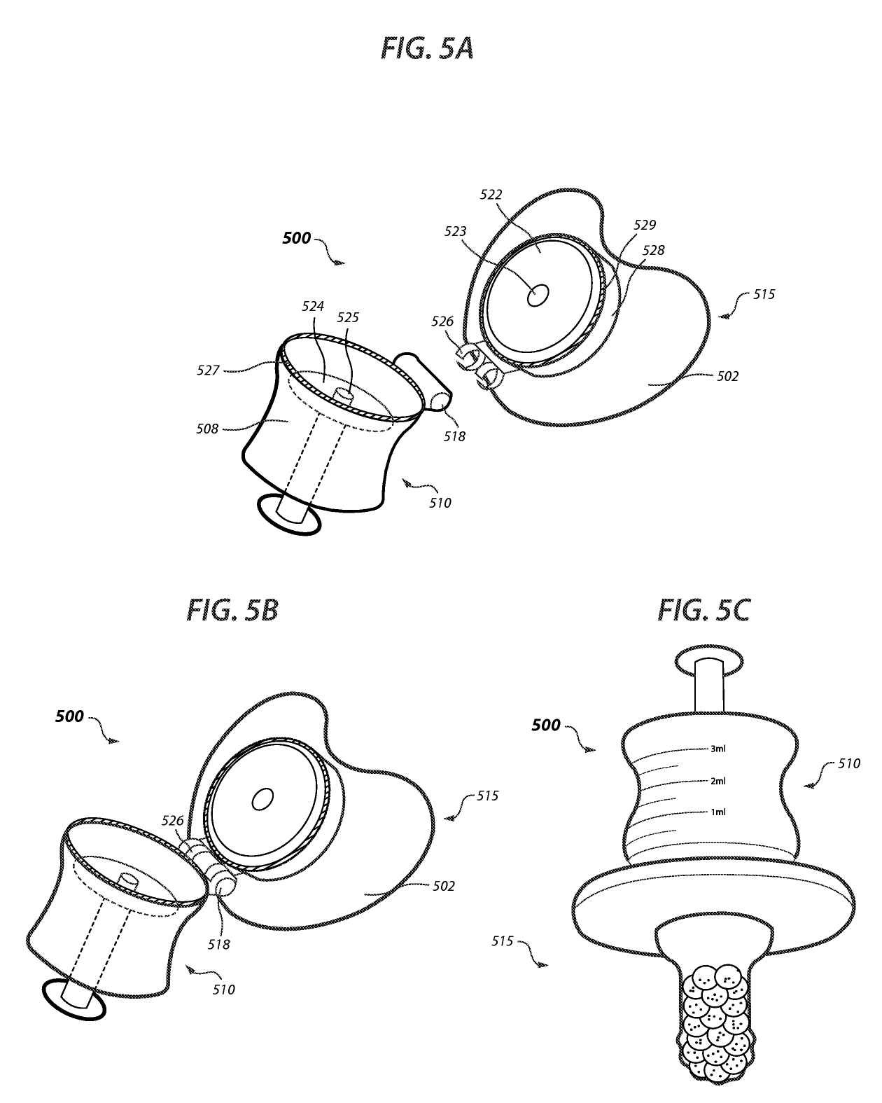

Moving forward through the figures, FIG. 5A illustrates a perspective view of a dispensing device in an disconnected and unlocked position according to an embodiment of the present invention. As shown, a manner in which chamber subassembly 510 is to be coupled to mouth guard subassembly 515 is illustrated. In particular, chamber subassembly 510 includes grooves 527 along the rim of chamber 508 and includes a connection rod 518 coupled to the edge of the chamber 508.

Mouth guard subassembly 515 includes a cooperating connection component, snap component 526, operable to snap fit connection rod 518 there through when the connection mechanism is engaged. Because the connecting mechanism is not engaged and the dispensing mechanism is not assembled, mouth guard subassembly 515 can serve as a conventional pacifier.

FIG. 5B illustrates a perspective view of a dispensing device 500 in a connected but unlocked position, according to an embodiment of the present invention. In an embodiment, a locking mechanism includes grooves 527 along the rim of chamber 508 and ridges 529 around a concentric raised portion 528 of mouth guard 502.

In an embodiment, grooves 527 and ridges 529 compliment each other such that ridges 529 fit within grooves 527 when the locking mechanism is engaged. In the embodiment, when the locking mechanism is engaged, the chamber subassembly 508 is fitted over the concentric raised portion 528 of mouth guard 502. Moreover, when the locking mechanism is engaged, the substance in chamber 508 is impeded from leaking out of dispensing device 500.

In an embodiment, once chamber subassembly 510 is connected to mouth guard assembly 515 via the connecting mechanism, the aforementioned components may also be locked together via the locking mechanism components described. Accordingly, once chamber subassembly 510 is connected to mouth guard 502, the connected assemblies form a dispensing device 500.

FIG. 5C illustrates a perspective view of a dispensing device in a connected and locked position according to an embodiment of the present invention. As shown, when dispensing device 500 is both connected and locked, the device 500 is readily available to dispense a substance contained therein upon a sucking action.

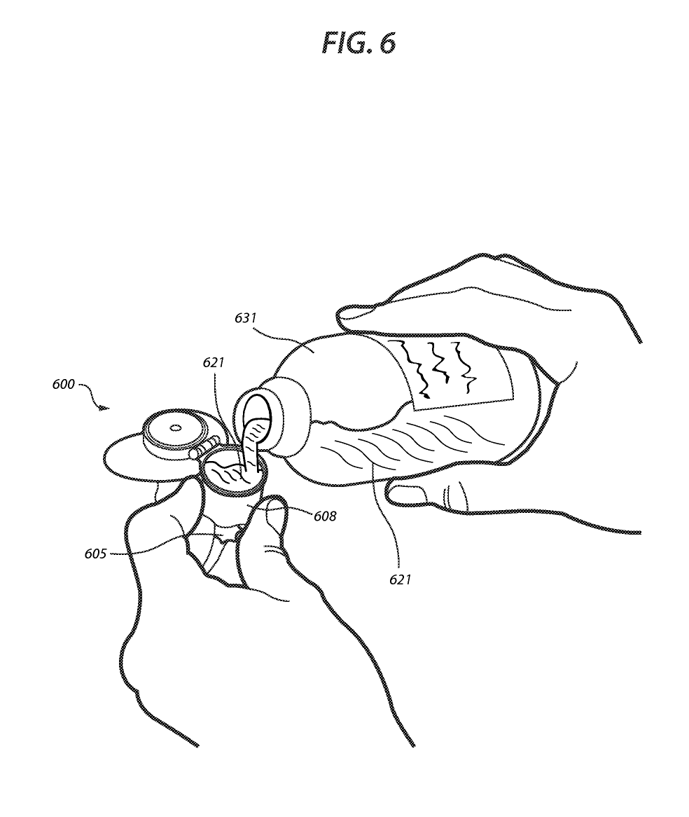

FIG. 6 illustrates a perspective view of an individual pouring a substance 621 into a dispensing device 600 according to an embodiment of the present invention. In the figure, an individual is shown pouring substance 621 from bottle 631 into the chamber 608 component of dispensing device 600. In addition, prior to pouring the substance 621, an administrator can pull out plunger 605 to inhibit the plunger 605 (or lid component) from interfering with the substance 621 while being poured into the chamber 608.

Once the substance 621 is poured into chamber 608, an administrator can engage the device 600 to move the contained fluid 621 from the container 608 to the nipple component of the device 600. Accordingly, once engaged, the device 600 can dispense the substance 621 upon a sucking action.

A dispensing mechanism system has been described. It will be understood by those having ordinary skill in the art that the present invention may be embodied in other specific forms without departing from the spirit and scope of the invention disclosed. In addition, the examples and embodiments described herein are in all respects illustrative and not restrictive. Those skilled in the art of the present invention will recognize that other embodiments using the concepts described herein are also possible.

We claim:

1. A device, comprising:
a chamber subassembly;
a mouth guard subassembly adjacent to an end of said chamber subassembly wherein said mouth guard subassembly includes a mouth guard and a nipple component having foam disposed within an interior portion therein; and
a connection mechanism operable to connect said chamber subassembly to said mouth guard subassembly when said connection mechanism is engaged and further operable to disconnect said chamber subassembly from said mouth guard subassembly when said connection mechanism is disengaged.

2. The device of claim 1, wherein said chamber subassembly includes a chamber and a plunger wherein said plunger is operable to extend through a first end of said chamber and is movable along a first axis of said chamber.

3. The device of claim 2, wherein said plunger includes a lid component at an end of said plunger operable to push a substance through said chamber.

4. The device of claim 1, wherein said connection mechanism includes a connection rod disposed on said chamber subassembly and a snap component disposed on said mouth guard subassembly.

5. The device of claim 4, wherein said mouth guard subassembly includes a coupling component operable to receive said connection rod to connect said mouth guard subassembly to said chamber subassembly.

6. The device of claim 1, wherein said nipple includes a plurality of pores operable to allow a substance to diffuse there through.

7. The device of claim 1 further comprising a plurality of foam components within the interior of said nipple.

8. The device of claim 1, wherein said foam is operable to absorb a substance disposed in said chamber subassembly.

9. The device of claim 8, wherein said foam is operable to release said substance upon a sucking action.

10. The device of claim 9, wherein said sucking action is performed by any selected from a group comprising an infant, toddler, senior, person with under-developed motor skills, person with impaired motor skills, and pet.

11. The device of claim 1 further includes at least one measurement tick mark on an exterior portion of said chamber subassembly.

12. A pacifier dispensing device for infants, comprising:
a chamber operable to contain a fluid-based medicament wherein a plunger is movable within said chamber through a first end along an axis parallel to the exterior walls of said chamber, wherein said plunger includes a lid component operable to push said fluid-based medicament through said chamber;
a mouth guard adjacent to a second end of said chamber wherein said mouth guard includes a cavity through which said fluid-based medicament flows to a nipple, wherein said nipple includes a plurality of pores; and
a foam member disposed within said nipple wherein said foam member is operable to absorb said fluid-based medicament and further operable to release said medicaments through said plurality of pores upon a sucking action on said nipple by an infant.

13. The pacifier dispensing device of claim 12 wherein said chamber contains approximately three milliliters of said fluid-based medicament.

14. The pacifier dispensing device of claim 12 wherein said nipple further includes a plurality of ridges.

15. The device of claim 12, wherein the shape of said foam component is shaped similarly to said nipple.

16. A method, comprising:
filling a chamber component within a chamber subassembly of a dispensing device with a substance;
engaging a locking mechanism of said dispensing device wherein said engaging causes said substance to be contained within said dispensing device;
operating a plunger component of said chamber subassembly to push said substance through said chamber and through a cavity of a mouth guard subassembly into a nipple adjacent to said mouth guard subassembly wherein a portion of said substance is absorbed by a plurality of foam components disposed within said nipple; and
administering the dispensing device to dispense said substance upon a sucking action.

17. The method of claim 16 further comprising:
disengaging said locking mechanism wherein said disengaging exposes a center exterior portion of said mouth guard subassembly; and
moving said plunger, having a lid component at one end, to prevent said lid component from interfering with a substance being poured in said chamber.

18. The method of claim 16 further comprising:
disengaging said locking mechanism after administering said substance;
disengaging a connecting mechanism;
separating said chamber subassembly from said mouth guard subassembly; and
utilizing said mouth guard subassembly as a pacifier device.

19. The method of claim 16 further comprising filling said chamber with a pre-determined amount of said substance.

20. The method of claim 16 wherein said substance is administered to any selected from the group comprising an infant, toddler, senior, persons whom lack the capacity to feed and administer nutrient-based fluids to themselves, and a pet.
